(19) United States
(12) Patent Application Publication
(10) Pub. No.: US 2026/0274533 A1
(43) Pub. Date: Sep. 17, 2026

(54) A TRANSPORTATION FRAME

(71) Applicant: EARTHECO GLOBAL PTY LTD, Brendale, Queensland (AU)

(72) Inventors: Jarad WILSON, Brendale, Queensland (AU); Wade PRICE, Brendale, Queensland (AU); Dermot LINDSAY, Brendale, Queensland (AU)

(21) Appl. No.: 19/469,176

(22) PCT Filed: Mar. 31, 2024
(86) PCT No.: PCT/AU2024/050303

§ 371 Date: Sep. 25, 2025

(30) Foreign Application Priority Data
Apr. 3, 2023 (AU) 2023900961

(51) Int. Cl. B65D 61/00; B65D 85/20

(52) U.S. Cl. CPC B65D 61/00; B65D 85/20

(57) ABSTRACT

A transportation frame for holding a plurality of items together, said transportation frame including: at least two frame members, including a first frame member and a second frame member, connectable together to form the transportation frame, each frame member including a pair of opposed ends; and at least a pair of locking arrangements for releasable securing the frame members together at adjacent ends to permit the first frame member to be selectively locked and unlocked relative to the second frame member so that the first frame member can be selectively detached and re-attached relative to the second frame member, each locking arrangement including: at least two leg formations operatively associated with ends of the first frame member, at least one leg formation orientated in a transverse direction to at least one other leg formation; a receiving opening defined at an end of the second frame member and configured to at least partially receive a leg formation for attachment and orientation of the first frame member relative to the second frame member; a locking catch operatively associated with the receiving opening; and a locking element operatively associated with each leg formation and releasably connectable to the locking catch when the leg formation is received in the receiving opening for securing, or locking, the first frame member relative to the second frame member.

### FIELD OF THE INVENTION

This invention relates to a transportation frame. In particular, the invention relates to the transportation of pipes and therefore will be described in this context. However, it would be appreciated that the transportation frame may be used to transport a variety of other items such as wood beams, reinforcement bars, poles or the like elements.

### BACKGROUND OF THE INVENTION

The transportation of pipes from one location to another is a common task in many industries, including construction, oil and gas, and manufacturing. The pipes are often large, heavy, and awkwardly shaped, making transportation challenging and potentially dangerous. Accordingly, transportation frames are used to transport pipes in bulk to make both carrying and moving the pipes efficient.

Typically, transportation frames are formed from a rectangular wooden frame formed from four wooden frame members that are nailed together around a bundle of pipes. The wooden frame is formed by nailing individual frame members together. Common issues with wooden frames for the transportation of pipes includes a lack of strength which can cause a catastrophic failure of the frame, the pipes easily slipping along the wooden frames, and the wooden frame being environmentally unfriendly due to their propensity to be used for only a single transport.

The applicant has invented a transportation frame as disclosed in International Patent Application No. PCT/AU2021/051456, which addresses the issues of a traditional wooden transportation frame. This new transportation frame can support large loads, provides grooves along the frame member to assist in preventing unwanted slippage, is designed for re-use and is made from injection moulded plastic which is recyclable. The one issue with this transportation frame is the large amount of capital necessary to produce different-sized plastic moulds to make different-sized pipe frames to cater for different-sized pipe bundles.

International Patent Application No. PCT/AU2021/051456 is hereby incorporated by reference. It will be clearly understood that, if a prior art publication is referred to herein, this reference does not constitute an admission that the publication forms part of the common general knowledge in the art in Australia or in any other country.

### Object of the Invention

It is an object of the invention to overcome and/or alleviate the abovementioned problems and/or provide the consumer with a useful or commercial choice.

### SUMMARY OF THE INVENTION

According to a first aspect, the invention resides in a transportation frame for holding a plurality of items together, said transportation frame including:
at least two frame members, including a first frame member and a second frame member, connectable together to form the transportation frame, each frame member including a pair of opposed ends; and
at least a pair of locking arrangements for releasable securing the frame members together at adjacent ends to permit the first frame member to be selectively locked and unlocked relative to the second frame member so that the first frame member can be selectively detached and re-attached relative to the second frame member, each locking arrangement including:
   at least two leg formations operatively associated with ends of the first frame member, at least one leg formation orientated in a transverse direction to at least one other leg formation;
   a receiving opening defined at an end of the second frame member and configured to at least partially receive a leg formation for attachment and orientation of the first frame member relative to the second frame member;
   a locking catch operatively associated with the receiving opening; and
   a locking element operatively associated with each leg formation and releasably connectable to the locking catch when the leg formation is received in the receiving opening for securing, or locking, the first frame member relative to the second frame member

According to a second aspect, the invention resides in a transportation frame for holding a plurality of items together, said transportation frame including:
at least two frame members, including a first frame member and a second frame member, connectable together to form the transportation frame, each frame member including a pair of opposed ends;
at least two leg formations operatively associated with ends of the first frame member, at least one leg formation orientated in a transverse direction to at least one other leg formation;
at least one receiving opening defined at an end of the second frame member and configured to at least partially receive the at least one leg formation for attachment and orientation of the first frame member relative to the second frame member;
a locking catch operatively associated with the receiving opening; and
a locking element operatively associated with the leg formation and releasably connectable to the locking catch when the leg formation is received in the receiving opening for securing, or locking, the first frame relative to the second frame.

The transportation frame may be used to transport a variety of different elongate items such as pipes. Accordingly, the transportation frame may be a pipe frame.

As indicated, the transportation frame may be configured to circumferentially extend around a bundle of pipes to keep the pipes together and assist in storage, handling and transport of the bundle of pipes, particularly road transport on trailer of a truck.

The transportation frame may be of any suitable size, shape and construction and may be formed from any suitable material or materials. Generally, the transportation frame may be formed from metal and/or plastic material or materials, preferably the latter, more preferably a settable polymeric material.

The transportation frame may be rectangular, circular, triangular, pentagonal or any variation or combination thereof, preferably rectangular.

Typically, the transportation frame may be formed from eight or more frame members joined together.

In preferred embodiments, the transportation frame may include four first frame members and four second frame members. The first frame members may be a corner frame members whilst the second frame members may be a side frame member.

Each corner frame member may include a corner body and two leg formations. The two leg formations may be orientated substantially perpendicularly with respect to each other.

Each side frame member may include a side body. The side body may be substantially uniform in cross sectional shape along its length.

The frame members may be of tubular or solid construction, preferably the former. Each frame member may have a substantially circular, oval or rectangular cross-section, preferably rectangular.

Each frame member may include a pair of opposed ends and a body having at least one sidewall extending therebetween, preferably in a linear direction. The elongate body may preferably be defined by four sidewalls, including an inner wall, an opposed outer wall and opposed side walls.

The frame members may be constructed in any suitable way. For example, the frame members may be machine folded, extruded or moulded.

In preferred embodiments, the frame members may be formed by extrusion and/or injection moulding, preferably from a polymeric material, such as, e.g., polyethylene or polypropylene. For example, the upper and lower frame members may be formed by injection moulding and the side frame members may be extrusions.

Each frame member may be of a tubular construction. In some embodiments, the frame members may include one or more internal walls and/or ribs to provide suitable mechanical strength while keeping the frame member light so that it can be readily handled and carried by an operator without special equipment, such as, e.g., hoists and cranes.

The various frame members may be of any suitable length, may have a width of about 30-80 mm, a height of about 30-50 mm.

The frame members may have a wall thickness that varies. For example, the wall thickness may range from 3-20 mm, preferably 8-15 mm.

As indicated, the transportation frame further includes at least one locking arrangement for joining the various frame members together in an end-to-end arrangement to form the transportation frame.

The at least one locking arrangement may be of any suitable size, shape and construction to permit the ends of frame members of the transportation frame to be detached and re-attached relative to other frame members.

Generally, one locking arrangement may permit a pair of frame members to be releasably joined together. Accordingly, a pair of locking arrangements provided on adjacent ends may be provided for joining at least four frame members together to form the transportation frame. Conversely, eight frame members locking arrangements provided on adjacent ends may be provided for joining four frame members together to form the transportation frame.

In some embodiments, the at least one locking arrangement may permit a selected frame member to be manually detached from the other frame members by a quick release mechanism. Preferably, the quick release mechanism may enable the detaching of the first frame member at a first end relative to a second frame member for detachment therefrom.

Typically, the at least one locking arrangement may include complementary engagement formations associated with the ends of the respective first and second frame members configured to engage with each other for attaching the first frame member relative to the second frame member.

The complementary engagement formations may be integrally formed with the ends of the frame members or may be of separate construction joined to the ends of the frame members, preferably integrally formed.

The complementary engagement formations may include a first formation associated with an end of the first frame member and a second formation connectable to the first formation and associated with an end of the second frame member for attaching the frame members together in an end-to-end arrangement.

In preferred embodiments, the complementary engagement formations may include at least one leg formation and a corresponding at least one receiving opening for at least partially receiving the leg formation for joining the frame members together.

The at least one leg formation may be provided on at least one end of the first frame member, preferably both ends.

The at least one leg formation may include one or more fillet and curve elements to maintain a high strength to weight ratio. The one or more fillets and curves may be defined on the opposed sidewalls of the leg formation. Advantageously, the one or more fillet and curve elements may reduce peak load stress and maximise corner strength while maintaining minimum mass.

Preferably, each of the opposed ends of the first frame member, may curve to some extent to provide a smooth transition into, and at least partially define the leg formation at each end of the first frame member.

The receiving opening may be defined in, or formed by, an open end of the second frame member, preferably the opposed side frame members. The receiving opening may be suitable sized and shaped to snugly receive a leg formation.

In some embodiments, the four sidewalls of the second frame member, or opposed side frame members, may define the receiving opening at each end.

In other embodiments, the receiving opening may be defined in an insert configured to be received in each end of the second frame member.

Advantageously, the engagement of each leg formation with a corresponding receiving opening orientates the first frame member, for attachment to the opposed side frame members for forming the transportation frame. This simplifies and speeds up assembly of the transportation frame, particularly when compared to conventional transportation frames that include complicated connectors often requiring additional tooling.

Further, by being snugly received in the receiving openings, the leg formations advantageously provide some rigidity to a partially assembled transportation frame ensuring.

In some embodiments, the at least one locking arrangement may be configured to automatically secure, or lock, the first frame member relative to the second frame member when a leg formation of the first frame member is at least partially received in the receiving opening associated with an adjacent end of the second frame member.

As indicated, the locking arrangement further includes a locking catch operatively associated with the receiving opening and a locking element operatively associated with a leg formation and configured to be releasably connectable to the locking catch when the leg formation is received in the receiving opening.

In use, engagement of the locking catch with the locking element may advantageously prevent the leg formation from being axially removed from the receiving opening thereby securing, or locking, the first frame member, or the upper or lower frame member, relative to the second frame member.

Each of the locking catch and the locking element may be of any suitable size, shape and construction to be engagement with one another to releasably secure the leg formation to the receiving opening.

For example, in some embodiments, the locking catch may include a female formation configured to at least partially receive, or mate with, a male formation of the locking element. The mateable male and female formations may couple together in any suitable way, such as, e.g., an interference (snap-fit) connection or a friction fit connection.

In other embodiments, the locking catch may include a protrusion or depression defined in an outer sidewall adjacent the receiving opening and the locking element may include a locking tongue associated with the at least one leg formation and sized and shaped to engage with the protrusion or depression when the at least one leg formation is inserted into the receiving opening.

In preferred embodiments, the locking catch includes a locking aperture defined a sidewall of the second frame member, or the opposed side frame members, at or near the receiving opening, and the locking element is configured to project through the locking aperture when the leg formation is inserted into the receiving opening, preferably biased to displace outwardly into the locking aperture.

The locking element may be of any suitable size, shape and construction.

For example, in some embodiments, the locking element may be spring-loaded, or -mounted, on the leg formation and configured to spring outwardly from the leg formation when it is in register with the locking aperture.

In other embodiments, the locking element may be integrally formed with the leg formation and may include a resilient finger configured to be biased away from the leg formation and into engagement with the locking aperture when the leg formation is inserted into the receiving opening to thereby automatically secure the first frame, or upper or lower frame member, relative to the second frame member, or the opposed side frame members, when the leg formation is inserted into the receiving opening.

In some embodiments, the resilient finger of the locking element may further include a locking tab on a distal end thereof configured to be received within the locking aperture, preferably to displace outwardly into the locking aperture, more preferably to protrude through the locking aperture and out past the outer sidewall of the frame member.

In some such embodiments, the locking tab may include a visual indicator so as to readily indicate when the first frame member, or upper or lower frame members, are secured, or locked, relative to the second frame member, or the opposed side frame members. The visual indicator may include a bright colour or combination of colours that is readily visible, such as, e.g., a fluorescent orange, yellow or green colour.

Advantageously, in such embodiments, the visual indicator may provide quick visible feedback to an operator assembling the transportation frame and/or to a driver before transporting a bundle of pipes, that the transportation frame components are secured relative to each other.

In other such embodiments, the locking tab may also provide an audible indicator as the at least one locking tab clicks into engagement with the locking aperture so as to readily indicate when the first frame member, or the upper or lower frame members, are secured, or locked, relative to the second frame member, or the opposed side frame members.

In use, the locking element may be disengaged from the locking catch by depressing the resilient finger of the locking element against its bias out of engagement with the locking catch, preferably locking aperture. In preferred embodiments, the protruding locking tab may be depressed out of engagement with the locking aperture against the bias of the resilient finger such that the leg formation may then be axially removed from the receiving opening to thereby detach an end of the first frame member, or upper or lower frame member, relative to the second frame member, or opposed side frame member.

Advantageously, the locking catch and elements secure the frame member relative to each other to provide a sturdy transportation frame yet also enable the frame members to be manually detached from each other quickly and easily and without additional tools.

In some embodiments, at least one of the frame members forming the transportation frame may have an outer surface of a wall that has been modified to increase its coefficient of friction, preferably an outer surface of an outer wall of an upper and/or lower frame member.

The surface may be modified in any suitable way to increase its coefficient of friction. For example, the surface may have scales, ribbing, grooves or knurling defined thereon.

In some embodiments, the surface may have a plurality of grooves or ribbing defined thereon. The grooves or ribbing may extend transversely or longitudinally relative to a length of the frame member. The grooves or ribbing may be located only on the second frame members.

In such embodiments, the coefficient of friction may be increased to at least 0.5, preferably from about 0.55 to about 0.58. By way of comparison, conventional transportation frames made from wooden slats or frame members have a coefficient of friction of about 0.4.

Advantageously, by increasing the coefficient of friction via the plurality of grooves defined on the outer surface of the outer wall of the upper and lower frame members, the grip of the transportation frame on trailer load deck and/or with other like transportation frames arranged in a stacked arrangement may be increased and thereby provide a stabler load during transport.

In some embodiments, an inner wall of at least one of the frame members may include a plurality of grooves defined thereon and extending in a transverse orientation relative to a longitudinal axis of the frame member, preferably an inner wall of at least one of the upper and lower frame members.

Each groove may be configured to at least partially receive at least part of one of the plurality of pipes.

Advantageously, the plurality of grooves defined on the inner walls of the frame members may stabilise and/or secure the transportation frame relative to the plurality of pipes encompassed thereby providing a more stable load during transport again.

According to a third aspect, the invention resides in a method of producing a customised transportation frame, the method include the steps of:
producing at least four corner frame members;
producing at least for side frame member of a desired size based on the desired size of the transportation frame;
connecting the four corner frame members to respective side frame members to produce the customised transportation frame.

Further features of the invention will become apparent from the detailed description below.

### BRIEF DESCRIPTION OF THE DRAWINGS

Embodiments of the invention will be described, by way of example only, with reference to the accompanying figures in which:

FIG. 1A is an upper perspective view of a pipe frame according to an embodiment of the present invention;

FIG. 1B is a lower perspective view of the pipe frame shown in FIG. 1A;

FIG. 2A is an upper perspective view of a corner frame member used to produce the pipe frame shown in FIG. 1A;

FIG. 2B is a lower perspective view of the corner frame member shown in FIG. 2A;

FIG. 3A is an upper perspective view of a side frame member used to produce the pipe frame shown in FIG. 1A;

FIG. 3B is a lower perspective view of the side frame member shown in FIG. 3A;

### DETAILED DESCRIPTION OF THE PREFERRED EMBODIMENTS

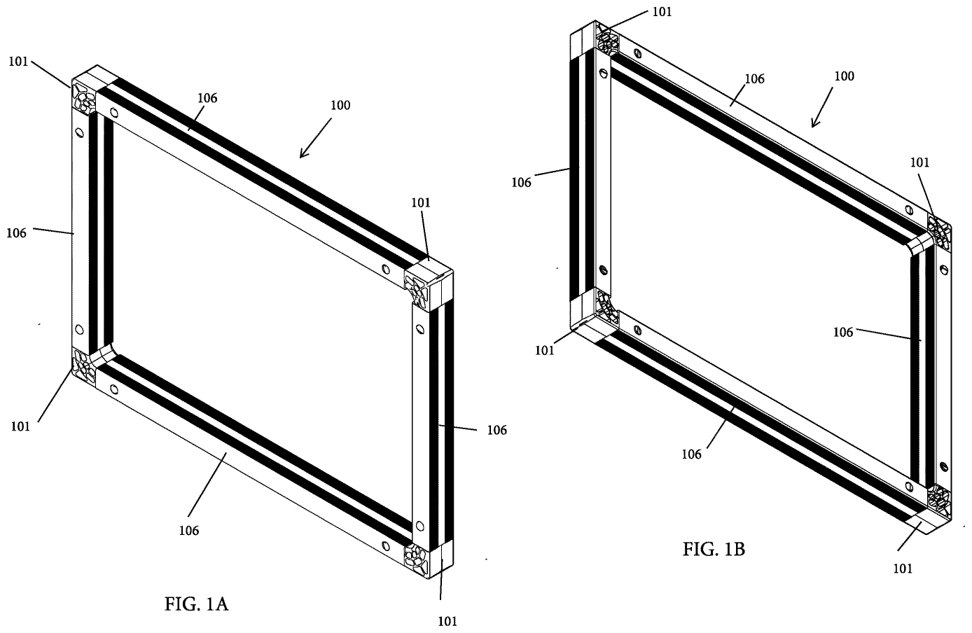

FIGS. 1A and 1B show a transport frame in the form of a pipe frame (100), used to carry pipes. However, it would be appreciated by a person skilled in the art that the pipe frame (100) can be used to convey other elongate items. As shown, the pipe frame (100) has a generally rectangular shape with the frame.

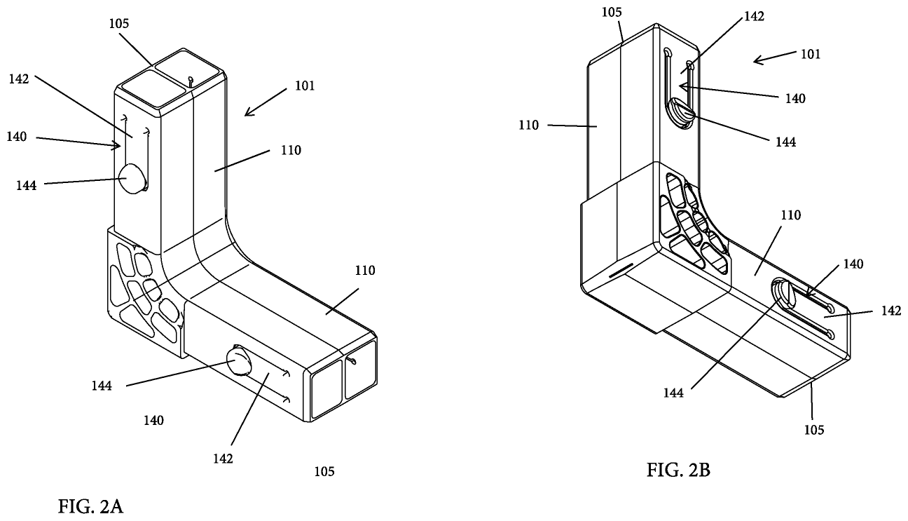

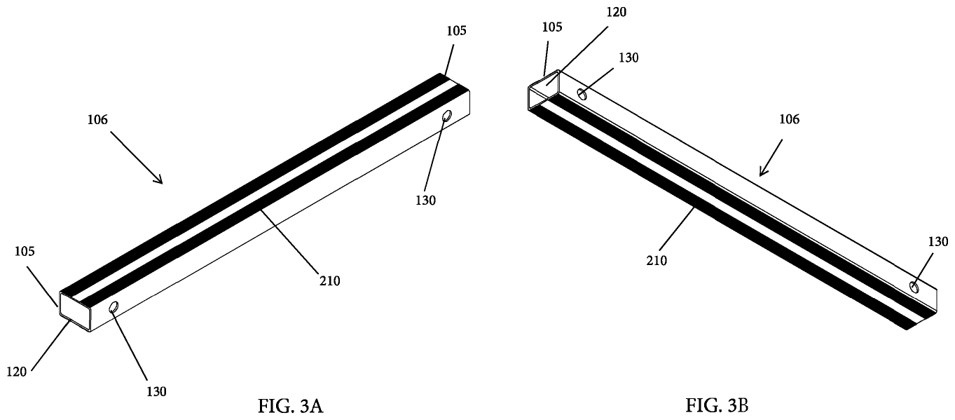

The pipe frame (100) includes four corner frame members (101) shown in more detail in FIGS. 2A and 2B, and four side frame members (106) shown in more detail in FIGS. 3A and 3B. The four side frame members (106) extend between the opposed ends (105) of the four corner frame members (101) to form the pipe frame (100).

Each end (105) of the four corner frame members (101) includes two leg formations (110). The leg formations (101 are perpendicular with respect to each other.

Each end (105) of the opposed side frame members (106) defines a receiving opening (120) configured to at least partially receive a respective leg formation (110) for attachment and orientation of the side frame members (106).

Each receiving opening (120) further includes a locking aperture (130; i.e., locking catch) and each leg formation (110) further includes a locking element (140) configured to be releasably connectable to a locking aperture (130) when a leg formation (110) is received in a receiving opening (120) for securing, or locking, to a connected side frame member (106).

The frame members (101, 106) are formed from a settable polymeric material. The corner frame members (101) are integrally formed with the leg formations (110) by injection moulding. The opposed side frame members (106) are extrusions.

Each frame member (101, 106) is of a tubular construction having a transverse rectangular cross-section. As shown, the corner frame members (101) include one or more internal walls and ribs to provide suitable mechanical strength while keeping the frame member light so that it can be readily handled and carried by an operator without special equipment, such as, e.g., hoists and cranes.

The receiving opening (120) defined in each end (105) of the opposed side frame members (106) is configured to snugly receive a leg formation (110) located on a corner frame member (101). Engagement of each leg formation (110) with a corresponding receiving opening (120) orientates the corner frame members (101) for attachment to the other side frame members (106) for forming the pipe frame (100). This simplifies and speeds up assembly of the pipe frame (100), particularly when compared to conventional pipe frames that include complicated connectors often requiring additional tooling.

Further, by being snugly received in the receiving openings (120), the leg formations (110) advantageously provide rigidity to a partially assembled pipe frame (100).

Each leg formation (110) further includes a locking element (140) for engaging with a corresponding locking aperture (130) when the leg formation (110) is inserted into a corresponding receiving opening (120) for securing, or locking, the leg formation (110) to a respective side frame member (106).

The locking aperture (130) is defined in a sidewall of each side frame member (106) near the end (105) and has a substantially circular shape.

The locking element (140) is integrally formed with the leg formation (110) and includes a resilient finger (142) configured to bias outwards away from the leg formation (110) and into engagement with a corresponding locking aperture (130) when the leg formation (110) is inserted into the receiving opening (120) to thereby automatically secure the a side frame member (106).

As shown, the resilient finger (142) further includes a locking tab (144) on a distal end thereof configured to protrude through a locking aperture (130) and out past the outer sidewall of the frame member (106).

Advantageously, the locking tab (144) functions as a visual indicator and provides quick visible feedback to an operator assembling the pipe frame (100) and/or to a driver before transporting a bundle of pipes, that the pipe frame (100) components are secured relative to each other.

In use, the locking element (140) can be disengaged from the locking aperture (130) by depressing the locking tab (144) against the bias of the resilient finger (142) out of engagement with the locking aperture (130), so that the transverse leg formation (110) can then be axially removed from the receiving opening (120) to thereby detach a corner frame member (101) from the side frame member (106).

Advantageously, the locking apertures and elements (130, 140) secure the frame members (101, 106) relative to each other to provide a sturdy pipe frame (100) yet also enable the frame members (101, 106) to be manually detached from each other quickly and easily and without additional tools.

The surface of the outer wall of the side frame members (106) have a a plurality of grooves (210) is increase the outer walls coefficient of friction. The grooves (210) extend along the length of each frame side frame member (102), and, consequently, the coefficient of friction is increased to at least 0.58. By way of comparison, conventional pipe frames made from wooden slats or frame members have a coefficient of friction of about 0.4.

Advantageously, by increasing the coefficient of friction via the plurality of grooves (210) defined on the surface of side frame members (106), the grip of the pipe frame (100) on a trailer load deck and/or with other like pipe frames arranged in a stacked arrangement is increased thereby providing a stabler load during transport.

Each leg formation (110) includes a plurality of fillet and curve elements (114) defined in opposed side walls to maintain a high strength to weight ratio and reduce peak load stress.

An advantage of having corner frame members (101) and side frame members (106) is that it is relatively easy to create a customised pipe frame (100). The corner frame members (101) are unchanged regardless of the desired size of the pipe frame (100). The length height of the pipe frame (100) can be varied by varying the length of the side frame members (106).

As the side frame members (106) are extruded, they can be cut to the desired size depending on the desired size of the pipe frame and whether the side frame member (106) is to be vertically or horizontally orientated. Once cut to size, holes are drilled adjacent the respective ends (105) to form a locking aperture (130). The corner frame members (101) are then connected to the side frame members using the locking apertures (130) and locking elements (1400 as described above.

As the corner frame members (106) are not required to be changed for different-sized pipe frames (100) and side frame members (106) can be cut to a desired size for different-sized pipe frames (100), there is a substantial reduction in capital cost. That is, only two machines are required to produce an infinite number of different-sized pipe frames.

It would be appreciated that the pipe frame (100) described above can be utilised in the same manner as the pipe frame (100) described and incorporated by reference in International Patent Application No. PCT/AU2021/051456.

In this specification, the terms “comprise”, “comprises”, “comprising” or similar terms are intended to mean a non-exclusive inclusion, such that a system, method or apparatus that comprises a list of elements does not include those elements solely but may well include other elements not listed.

In this specification, terms such as upward, downward, horizontal and vertical, and their grammatical derivatives, are used to describe the invention in its normal orientation and are not to be construed to limit the invention to any particular orientation.

The reference to any prior art in this specification is not, and should not be taken as, an acknowledgement or any form of suggestion that the prior art forms part of the common general knowledge.

It should be appreciated that various other changes and modifications may be made to the embodiments described without departing from the spirit or scope of the invention.

1. (canceled)

2. A transportation frame for holding a plurality of items together, said transportation frame including:
at least two frame members, including a first frame member and a second frame member, connectable together to form the transportation frame, each frame member including a pair of opposed ends;
at least two leg formations operatively associated with ends of the first frame member, at least one leg formation orientated in a transverse direction to at least one other leg formation;
at least one receiving opening defined at an end of the second frame member and configured to at least partially receive the at least one leg formation for attachment and orientation of the first frame member relative to the second frame member;
a locking catch operatively associated with the receiving opening; and
a locking element operatively associated with the leg formation and releasably connectable to the locking catch when the leg formation is received in the receiving opening for securing, or locking, the first frame relative to the second frame.

3. The transportation frame of claim 2 wherein the transportation frame is a pipe frame.

4. (canceled)

5. (canceled)

6. (canceled)

7. The transportation frame of claim 2 wherein the transportation frame is formed from eight or more frame members joined together.

8. The transportation frame of claim 2 wherein the transportation frame includes four first frame members and four second frame members.

9. The transportation frame of claim 2 wherein the first frame members are corner frame members whilst the second frame members are side frame members.

10. The transportation frame of claim 9 wherein each corner frame member includes a corner body and two leg formations.

11. The transportation frame of claim 10 wherein the two leg formations are orientated substantially perpendicularly with respect to each other.

12. The transportation frame of claim 9 wherein each side frame member include a side body, the side body being substantially uniform in cross sectional shape along its length.

13. The transportation frame of claim 2 wherein the at least one locking arrangement permits a selected frame member to be manually detached from the other frame members by a quick release mechanism.

14. The transportation frame of claim 12 wherein, the quick release mechanism is to enable the detaching of the first frame member at a first end relative to a second frame member for detachment therefrom.

15. The transportation frame of claim 2 wherein the at least one locking arrangement include complementary engagement formations associated with the ends of the respective first and second frame members configured to engage with each other for attaching the first frame member relative to the second frame member.

16. The transportation frame of claim 15 wherein the complementary engagement formations include a first formation associated with an end of the first frame member and a second formation connectable to the first formation and associated with an end of the second frame member for attaching the frame members together in an end-to-end arrangement.

17. The transportation frame of claim 15 wherein the complementary engagement formations include at least one leg formation and a corresponding at least one receiving opening for at least partially receiving the leg formation for joining the frame members together.

18. The transportation frame of claim 17 wherein at least one leg formation is provided on at least one end of the first frame member.

19. The transportation frame of claim 17 wherein the receiving opening is defined in, or formed by, an open end of the second frame member.

20. The transportation frame of claim 2 wherein the at least one locking arrangement is configured to automatically secure, or lock, the first frame member relative to the second frame member when a leg formation of the first frame member is at least partially received in the receiving opening associated with an adjacent end of the second frame member.

21. The transportation frame of claim 20 wherein the locking arrangement further includes a locking catch operatively associated with the receiving opening and a locking element operatively associated with a leg formation and configured to be releasably connectable to the locking catch when the leg formation is received in the receiving opening.

22. The transportation frame of claim 20 wherein the locking catch includes a locking aperture defined a sidewall of the second frame member, or the opposed side frame members, at or near the receiving opening, and the locking element is configured to project through the locking aperture when the leg formation is inserted into the receiving opening, preferably biased to displace outwardly into the locking aperture.

23. The transportation frame of claim 2 wherein a plurality of grooves or ribbing extends transversely or longitudinally relative to a length of the one or more of the second frame members.

24. A method of producing a customised transportation frame, the method include the steps of:
producing at least four corner frame members;
producing at least for side frame member of a desired size based on the desired size of the transportation frame; and
connecting the four corner frame members to respective side frame members to produce the customised transportation frame.
